(19) United States
(12) Patent Application Publication
(10) Pub. No.: US 2018/0309899 A1
(43) Pub. Date: Oct. 25, 2018

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Norio KUROSAWA, Mishima (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/695,497

(22) Filed: Sep. 5, 2017

(30) Foreign Application Priority Data
Apr. 21, 2017 (JP) 2017-084730

(51) Int. Cl. H04N 1/32; G03G 15/36

(52) U.S. Cl. CPC H04N 1/32352; G03G 15/36; H04N 2201/3238; H04N 2201/0094; H04N 1/32309

(57) ABSTRACT

An image forming apparatus includes a printer section and a controller. The printer section forms an image using a decolorable recording agent. The controller controls the printer section to form a concealing code image for concealing a secret code image indicating secret information which corresponds to a concealed object in an area at least a part of the secret code image with the decolorable recording agent in such a manner that the secret code image formed on the sheet cannot be decoded.

### CROSS-REFERENCE TO RELATED APPLICATION

This application is based upon and claims the benefit of priority from Japanese Patent Application No. 2017-084730, filed Apr. 21, 2017, the entire contents of which are incorporated herein by reference.

### FIELD

Embodiments described herein relate generally to an image forming apparatus.

### BACKGROUND

A technology which uses a decoloring recording agent to form an image for filling a code image which is a concealed object is proposed as a technology for concealing a code image such as a two-dimensional barcode. However, when the code image is concealed with such a technology, a concealed part is unnatural. Thus, people can easily find that any secret image exists at that position. In this case, the degree of confidentiality is reduced in some cases.

### DESCRIPTION OF THE DRAWINGS

FIG. 1 is an overall arrangement of an image forming apparatus;

FIG. 2 is a schematic block diagram of functional components of the image forming apparatus;

FIG. 3 is a specific example of a part of a code image;

FIG. 4 is a specific example of an image formed by the image forming apparatus; and

FIG. 5 is a flowchart of the operation of the image forming apparatus.

### DETAILED DESCRIPTION

In accordance with an embodiment, an image forming apparatus comprises a printer section and a controller. The printer section forms an image using a decoloring recording agent which is a decolorable recording agent. The controller controls the printer section to form a concealing code image for concealing a secret code image indicating secret information which is a concealed object on a sheet. The controller controls the printer section to form the concealing code image in an area containing at least a part of the secret code image with the decoloring recording agent in such a manner that the secret code image formed on the sheet cannot be decoded.

Hereinafter, an image forming apparatus of an embodiment is described in detail with reference to the accompanying drawings.

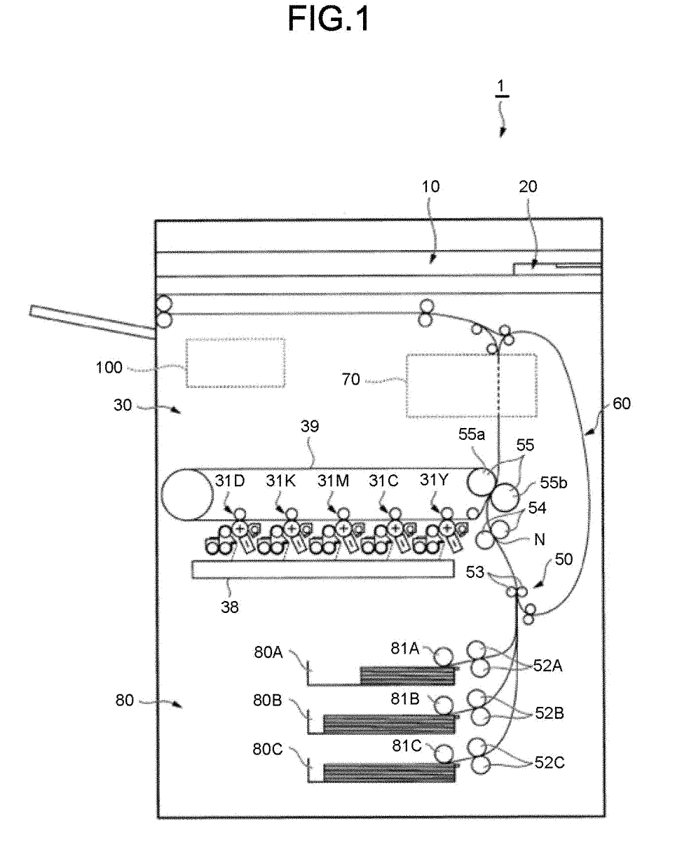

FIG. 1 is a diagram exemplifying the overall constitution of an image forming apparatus 1 according to an embodiment.

The image forming apparatus 1 of the embodiment is an MFP (Multi-Function Peripheral). The image forming apparatus 1 executes an image forming processing. The image forming processing is a processing of forming an image on a sheet. The sheet is, for example, a paper or a label paper. The image forming processing may be executed using a decolorable recording agent. The decoloring in the present embodiment means making an image formed with a color (including not only a chromatic color but also an achromatic color such as white and black) different from a color of a ground of the sheet visually invisible. The decoloring may be performed through heating of the recording agent. For example, the recording agent, such as a toner, may be heated to a temperature greater than a threshold temperature to achieve decoloring. The decoloring may be executed by a method other than decoloring by heating.

The image forming apparatus 1 includes an image reading section 10, a control panel 20, a printer section 30, a sheet housing section 80 and a controller 100. The printer section 30 fixes a visible image formed by using a recording agent (for example, a toner) on a sheet. In the following description, an apparatus for fixing a visible image formed using toner (a specific example of the recording agent) is described as an example.

The image reading section 10 reads image information which is a reading object as intensity of light. The image reading section 10 records the read image information. The recorded image information is output to the controller 100.

The control panel 20 includes a display section and an operation section. The display section is a liquid crystal display or an organic EL (Electro Luminescence) display. The display section displays various information relating to the image forming apparatus 1. The operation section includes an input device such as a plurality of buttons. The operation section receives an operation by the user. The operation section outputs a signal corresponding to the operation executed by the user to the controller 100. The control panel 20 may be constituted using a touch panel formed by the display section and the operation section integrally.

The printer section 30 executes the image forming processing. In the image forming processing, the printer section 30 forms an image on the sheet based on image information generated by the image reading section 10, image information received via a communication path, or image information generated by the controller 100. The printer section 30 in the present embodiment uses a decolorable toner (hereinafter referred to as a “decoloring toner”) and a toner that is not decolorable (hereinafter, referred to as a “normal toner”). The decoloring toner is a specific example of the decoloring recording agent. The normal toner is, for example, a non-decoloring recording agent.

The normal toner includes, for example, a yellow (Y) toner, a magenta (M) toner, a cyan (C) toner, and a black (K) toner. The decoloring toner is a colored toner like the normal toner, and is, for example, black or blue. The decoloring toner is decolorized at a temperature higher than a temperature at which the decoloring toner is fixed on the sheet. Under the control of the controller 100, the printer section 30 executes an image forming processing using the decoloring toner or an image forming processing using the normal toner. In the following description, an image forming processing with the decoloring toner is described as a decoloring printing, and an image forming processing with the normal toner is described as a normal printing.

The sheet housing section 80 includes a plurality of sheet feed cassettes 80A, 80B and 80C. Each of the sheet feed cassettes 80A, 80B and 80C stores a sheet of a predetermined size and type. The sheet feed cassettes 80A, 80B and 80C have pickup rollers 81A, 81B and 81C, respectively. Each of the pickup rollers 81A, 81B and 81C picks up the sheets one by one from each of the sheet feed cassettes 80A, 80B and 80C. The pickup rollers 81A, 81B, and 81C supply the picked sheets to a conveyance section 50.

The conveyance section 50 conveys the sheet picked up from the sheet housing section 80. The conveyance section 50 includes a sheet feed roller 52A, a sheet feed roller 52B, a sheet feed roller 52C, a conveyance roller 53, and a resist roller 54. The sheet feed rollers 52A, 52B and 52C convey the sheet supplied by the pickup rollers 81A, 81B and 81C to the resist roller 54. The resist roller 54 conveys the sheet to a transfer section 55 side according to a timing at which the transfer section 55 of the printer section 30 described later transfers a toner image onto the surface of the sheet. The resist roller 54 conveys the sheet to the transfer section 55 side after aligning a front end of the sheet sent by the conveyance roller 53 at a nip N.

The controller 100 controls the operation of the image forming apparatus 1. The detailed description of the controller 100 is described later.

Next, the detailed constitution of the printer section 30 is described. The printer section 30 includes a developing section 31, an exposure section 38, an intermediate transfer belt 39, the transfer section 55, an inversion unit 60 and a fixing section 70. The developing section 31 has predetermined categories of toner. In the following description, a developing section corresponding to yellow (Y) toner is described as a developing section 31Y, a developing section corresponding to magenta (M) toner is described as a developing section 31M, a developing section corresponding to cyan (C) toner is described as a developing section 31C, a developing section corresponding to the black (K) toner is described as a developing section 31K, and a developing section corresponding to the decoloring toner is described as a developing section 31D.

Each developing section 31 (31Y, 31M, 31C, 31K or 31D) supplies a developer in a developer housing section to a photoconductive drum. The developer housing section houses the developer. The developer is a mixture of a carrier composed of magnetic fine particles and each toner. If the developer is stirred, the toner is triboelectrically charged. Thus, the toner adheres to a surface of the carrier by electrostatic force. In the developer housing section, a first mixer, a second mixer, a developing roller, and a temperature and humidity sensor are arranged. The first mixer and the second mixer stir the developer. The first mixer and the second mixer convey the developer. The second mixer is arranged below a developing roller.

The second mixer supplies the developer housed in the developer housing section to the surface of the developing roller. The temperature and humidity sensor detects temperature and humidity of the inner side of the developer housing section as a state of the printer section 30.

The developing roller rotates counterclockwise by the driving of a developing motor. The developing roller is composed of a magnetic material (magnet) in which negative electrodes and positive electrodes are arranged alternately in a circumferential shape. The developer supplied by the second mixer brushes up on the surface of the developing roller according to a magnetic field distribution of the developing roller. As the developing roller rotates, the napped developer contacts the surface of the photoconductive drum in a sweeping manner. The magnetic field distribution of the developing roller is switchable. The developing section 31 switches the magnetic field distribution of the developing roller to execute napping and ear-breaking of the developer. The developing roller is connected to a voltage applying circuit. Under the control of the controller 100, the voltage applying circuit applies a voltage as a developing bias to the developing roller. The voltage applied to the developing roller is, for example, a negative DC voltage.

The photoconductive drum has a photoconductive layer on a surface thereof. The photoconductive drum rotates clockwise by the driving of the developing motor. Around the photoconductive drum, the developing section 31, a charging section, a discharging section, a cleaning unit and a transfer roller are arranged.

The charging section uniformly charges the surface (photoconductive layer) of the photoconductive drum. For example, the charging section charges the surface (photoconductive layer) of the photoconductive drum to negative polarity. As a result, a toner image is formed on the surface (photoconductive layer) of the photoconductive drum according to an electrostatic latent image.

For example, the developing section 31Y develops the electrostatic latent image on the surface (photoconductive layer) of the photoconductive drum with the yellow (Y) toner. The developing section 31M develops the electrostatic latent image on the surface of the photoconductive drum with the magenta (M) toner. The developing section 31C develops the electrostatic latent image on the surface of the photoconductive drum with the cyan (C) toner. The developing section 31K develops the electrostatic latent image on the surface of the photoconductive drum with the black (K) toner. The developing section 31D develops the electrostatic latent image on the surface of the photoconductive drum with the decoloring toner.

The cleaning unit scrapes off the toner that is not transferred on the surface of the photoconductive drum to remove it. The cleaning unit removes the toner on the surface of the photoconductive drum after the toner image is transferred from the photoconductive drum onto the intermediate transfer belt 39. The toner removed by the cleaning unit is collected in a waste toner tank to be discarded.

The discharging section faces the photoconductive drum across the cleaning unit. The discharging section illuminates the surface of the photoconductive drum with the light. As a result, the heterogeneous charge on the photoconductive layer becomes uniform. In other words, the charge of the photoconductive layer is removed.

The transfer roller faces the photoconductive drum across the intermediate transfer belt 39. The transfer roller abuts against the surface of the photoconductive drum across the intermediate transfer belt 39. The transfer roller transfers (primarily transfers) the toner image on the surface of the photoconductive drum onto the intermediate transfer belt 39.

The exposure section 38 is arranged at a position facing the photoconductive drum of each of the developing sections 31Y, 31M, 31C, 31K and 31D. The exposure section 38 irradiates the surface of the photoconductive drum of each of the developing sections 31Y, 31M, 31C, 31K and 31D with the laser light. The exposure section 38 is controlled to emit the light based on the image data under the control of the controller 100. The exposure section 38 emits the laser light based on the image data. In this way, the negative charge on the surface of the photoconductive drum of each of the developing sections 31Y, 31M, 31C, 31K and 31D is eliminated. As a result, a static electricity pattern is formed at a position irradiated with the laser light on the surface of the photoconductive drum. By irradiation of the laser light by the exposure section 38, the electrostatic latent image is formed on the surface of the photoconductive drum. In the exposure section 38, an LED (Light Emitting Diode) light may be used instead of the laser light.

The inversion unit 60 inverts the sheet discharged from the fixing section 70 by switchback. The inversion unit 60 conveys the inverted sheet to the front of the resist roller 54 again. Therefore, in the sheet conveyed by the inversion unit 60, a surface opposite to the surface subjected to a fixing processing faces the intermediate transfer belt 39. In the sheet which passes twice through the inversion unit 60, a surface same as the surface subjected to the fixing processing faces the intermediate transfer belt 39.

The fixing section 70 applies heat and pressure to the sheet. The fixing section 70 fixes the toner image transferred onto the sheet on the sheet by the heat and pressure.

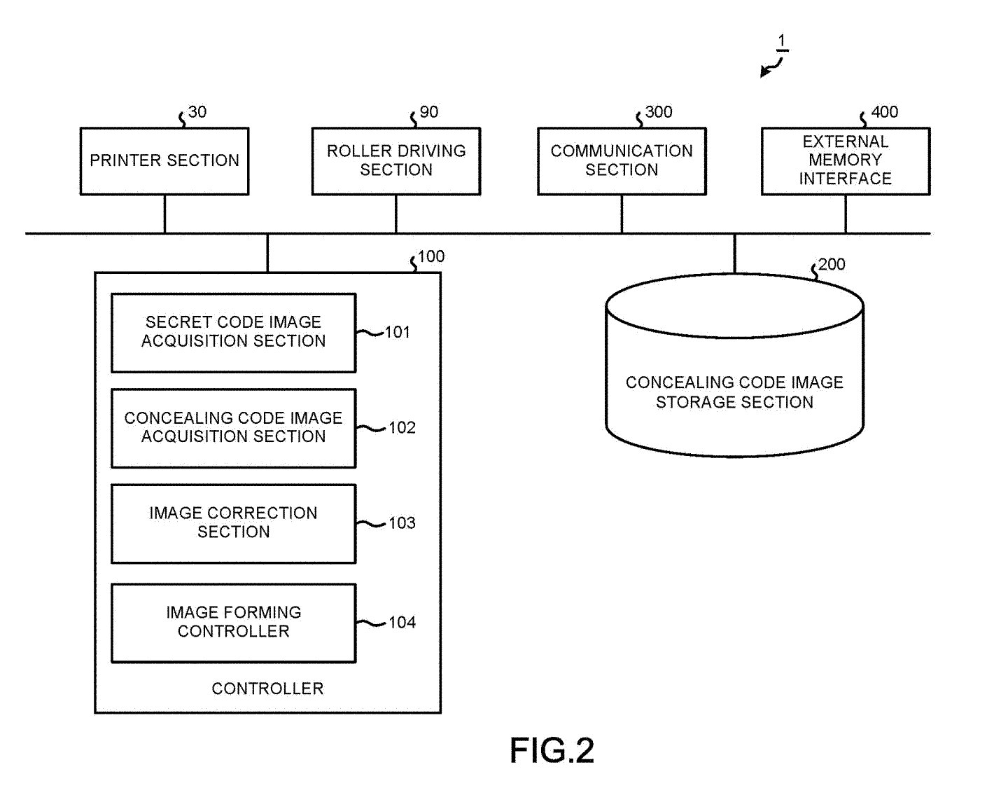

FIG. 2 is a schematic block diagram illustrating main functional components of the image forming apparatus 1. The image forming apparatus 1 includes the printer section 30, a roller driving section 90, the controller 100, a concealing code image storage section 200, a communication section 300 and an external memory interface 400.

The description of the printer section 30 is omitted as it is the same as that described above.

The roller driving section 90 is a driving device such as a motor. The roller driving section 90 rotates rollers provided in the conveyance section 50 and the inversion unit 60 by generating a driving force if receiving the supply of electric power. Through the driving by the roller driving section 90, the sheet is conveyed in the conveyance section 50 and the sheet is switched back by the inversion unit 60.

The controller 100 is constituted by a CPU (Central Processing Unit) and a memory. The CPU executes a program stored in the memory, and in this way, the controller 100 functions as a secret code image acquisition section 101, a concealing code image acquisition section 102, an image correction section 103 and an image forming controller 104.

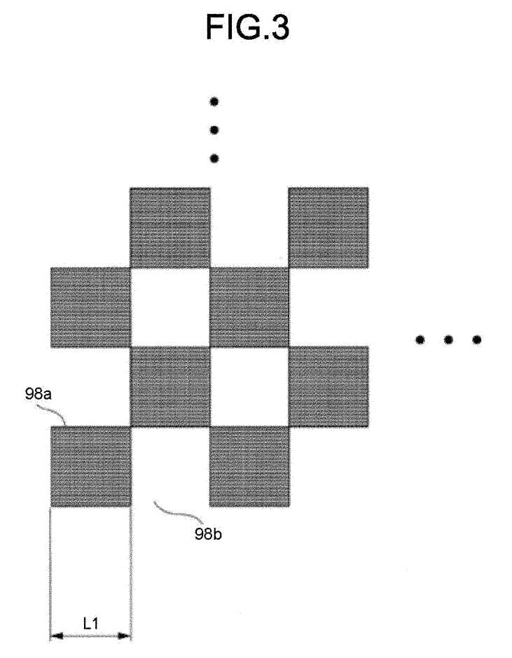

The secret code image acquisition section 101 acquires a secret code image. The secret code image indicates secret information which is a concealed object. The code image is acquired by encoding target information according to a predetermined coding method. The code image includes, for example, a barcode image or an image of a QR code (registered trademark). The code image is represented as an aggregate of predetermined unit images. FIG. 3 is a diagram illustrating a specific example of a part of the code image. As shown in FIG. 3, for example, the code image may be shown as a set of unit images (dark color parts 98a and light color parts 98b).The dark color part 98a is a part in which a unit image is painted with a relatively dark color. The light color part 98b is apart in which a unit image is painted with a relatively light color. The light color part 98b may be shown by being unpainted. The code image shows information before encoding according to an arrangement pattern of the dark color part 98a and the light color part 98b. The unit image may be constituted as a square with a predetermined length L1. The unit image may be constituted as a line having a predetermined width. The size of the unit image may be appropriately changed.

Retuning to FIG. 2 and continuing the description. The secret code image acquisition section 101 may acquire the secret code image through any processing. For example, the secret code image acquisition section 101 may acquire image data of the secret code image read by the image reading section 10. In this case, the image reading section 10 reads the secret code image previously formed on the sheet to generate the image data. For example, the secret code image acquisition section 101 may acquire the secret code image received from another device via the communication section 300. For example, the secret code image acquisition section 101 may acquire the secret code image recorded in an external memory connected to the external memory interface 400. The secret code image acquisition section 101 may acquire the secret code image by encoding the secret information before being encoded. In this case, the secret information may be received from another device via the communication section 300 or maybe acquired from the external memory via the external memory interface 400.

The concealing code image acquisition section 102 acquires the concealing code image. The concealing code image is used for concealing the secret code image which is a concealed object. The concealing code image is formed at a position to cover a part or all of the secret code image formed on the sheet. By forming an image in this manner, the secret code image cannot be decoded correctly.

The concealing code image acquisition section 102 may acquire the concealing code image through any processing. For example, the concealing code image acquisition section 102 may acquire image data of the concealing code image read by the image reading section 10. In this case, the image reading section 10 reads the concealing code image previously formed on the sheet to generate the image data. For example, the concealing code image acquisition section 102 may acquire the concealing code image received from another device via the communication section 300. For example, the concealing code image acquisition section 102 may acquire the concealing code image recorded in an external memory connected to the external memory interface 400. The concealing code image acquisition section 102 may acquire the concealing code image by reading the concealing code image previously stored in the concealing code image storage section 200. The concealing code image acquisition section 102 may acquire the concealing code image by encoding concealing information before being encoded. The concealing information is indicated by the concealing code image. The concealing information is used to conceal the secret information, and the concealing information need not be concealed. The concealing information may be received from another device via the communication section 300 or maybe acquired from the external memory via the external memory interface 400.

The image correction section 103 corrects either or both of the secret code image and the concealing code image. For example, if the sizes of the unit images are different between the secret code image and the concealing code image, the image correction section 103 may correct either or both of the secret code image and the concealing code image. In this case, the image correction section 103 executes enlargement or reduction processing so that the sizes of both unit images coincide.

According to an error correction capability of the secret code image, the image correction section 103 may correct the concealing code image so as to have an amount of the dark color parts at which the secret code image cannot be decoded with respect to the light color part of the secret code image. At this time, the correction may be executed by adding the dark color part to the concealing code image before correction within the error correction capability of the concealing code image before correction. By executing such correction, it is possible to conceal the secret code image in such a manner that the secret code image cannot be decoded while realizing decoding of the concealing code image after correction.

The image forming controller 104 controls the printer section 30 to execute the image forming processing on the sheet. If the concealing code image is formed on a sheet on which the secret code image is already formed, the image forming controller 104 controls the printer section 30 to form the concealing code image with the decoloring toner. If the image forming controller 104 forms an image on a sheet on which the secret code image is not formed, first, the image forming controller 104 controls the printer section 30 to form the secret code image with the non-decoloring toner (for example, black toner). Then, the image forming controller 104 controls the roller driving section 90 to convey the sheet in such a manner that the sheet surface on which the secret code image is formed becomes a printing surface. For example, the image forming controller 104 may control the roller driving section 90 so that the sheet passes twice through the inversion unit 60. Then, the image forming controller 104 forms the concealing code image on the sheet surface on which the secret code image is formed. The image forming controller 104 discharges the sheet on which the concealing code image is formed from a discharge section to the outside of the image forming apparatus 1.

The concealing code image storage section 200 is constituted using a storage device such as a magnetic hard disk device or a semiconductor storage device. The concealing code image storage section 200 stores the concealing code image. The concealing code image stored in the concealing code image storage section 200 maybe acquired by the concealing code image acquisition section 102 and formed on the sheet.

The communication section 300 is a communication interface. The communication section 300 executes data communication with another device via a wireless communication path or a priority communication path. For example, the communication section 300 may receive data of the secret code image and data of the secret information from other devices. For example, the communication section 300 may receive data of the concealing code image and data of the concealing information from another apparatus.

The external memory interface 400 is an interface for executing data communication with the external memory. The external memory interface 400 may be constituted as a USB (Universal Serial Bus) port, for example. The external memory interface 400 may be constituted to receive data from external memory, for example, by non-contact communication.

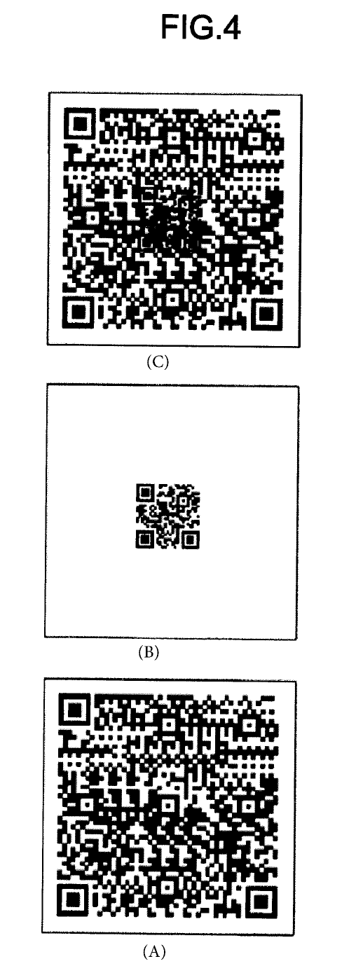

FIG. 4 is a diagram illustrating a specific example of an image formed by the image forming apparatus 1. FIG. 4(A) is a diagram illustrating a specific example of the concealing code image. FIG. 4(B) is a diagram illustrating a specific example of the secret code image. FIG. 4(C) is a diagram illustrating a specific example of image formation of the concealing code image by the image forming apparatus 1. As shown in FIG. 4(A) and FIG. 4(B), it is desirable that the concealing code image is larger than the secret code image. In the examples in FIG. 4(A) and FIG. 4(B), the sizes of the unit images of the concealing code image and the secret code image are different. The secret code image acquisition section 101 and the concealing code image acquisition section 102 of the controller 100 may acquire code images having unit image sizes in coincident size. If the size of the unit image is different in the acquired code image, the image correction section 103 may match the sizes of the unit images by enlarging or reducing one or both of the code images.

In the example in FIG. 4(C), the concealing code image is formed in such a manner that the secret code image is located at the center thereof. However, the position of the concealing code image does not need to be limited to such a position that the secret code image is located at the center in this way.

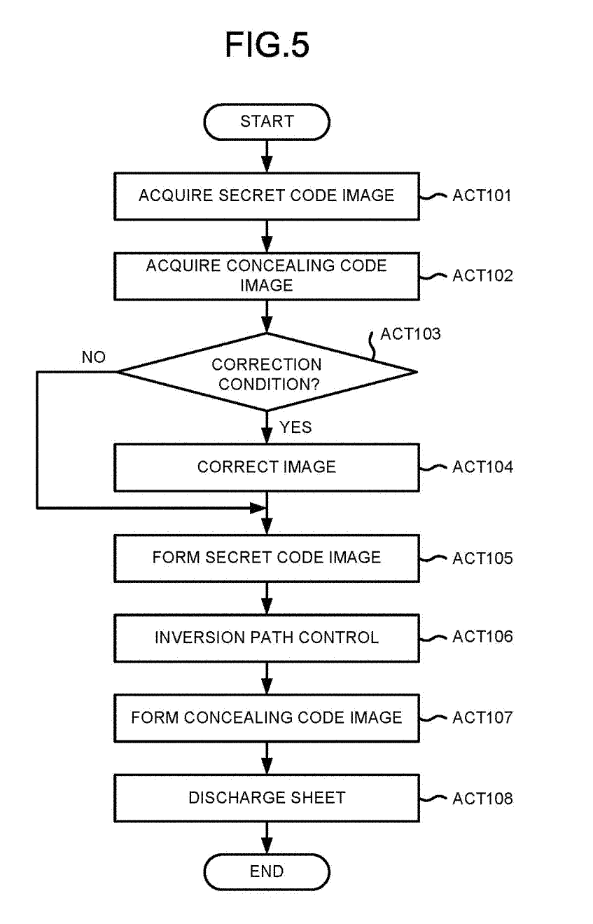

FIG. 5 is a flowchart illustrating an example of the flow of the operation of the image forming apparatus 1. The processing shown in FIG. 5 has procedures in a case of forming the secret code image and the concealing code image on the sheet. First, the secret code image acquisition section 101 acquires the secret code image (Act S101). Next, the concealing code image acquisition section 102 acquires the concealing code image (Act S102). The image correction section 103 determines whether or not a predetermined correction condition is satisfied in the secret code image and the concealing code image (Act S103). If the correction condition is satisfied (YES in Act S103), the image correction section 103 executes the correction processing according to the condition (Act S104). For example, if the condition that the sizes of the unit images are different between the secret code image and the concealing code image is satisfied, the image correction section 103 executes a unit image matching processing. In the unit image matching processing, the image correction section 103 matches the sizes of the unit images by executing one or both of an enlargement processing and a reduction processing.

After the processing in Act S104 or if the correction condition is not satisfied in Act S103 (NO in Act S103), the image forming controller 104 executes the image forming processing. More specifically, the image forming controller 104 first forms the secret code image on the sheet with the non-decoloring toner (Act S105). The image forming controller 104 then controls the roller driving section 90 to drive the rollers in the inversion unit 60. By the driving, the sheet is conveyed in such a manner that the same surface as the surface subjected to the fixing processing faces the intermediate transfer belt 39 (Act S106). The image forming controller 104 forms the concealing code image at a position where at least a part of the secret code image formed in Act S105 is covered (Act S107). Then, the image forming controller 104 discharges the sheet from the discharge section (Act S108).

In the image forming apparatus 1 arranged in this manner, the degree of confidentiality of the code image can be improved. Hereinafter, such an effect is described in detail. In the image forming apparatus 1, the concealing code image formed to cover the secret code image is formed so that the predetermined information can be acquired by decoding. Therefore, the secret code image can be concealed naturally rather than in an unnatural manner. If a painted rectangle is formed to just cover the secret code image, the existence of the rectangle often becomes unnatural. Those (hereinafter, referred to as “user”) who touch the sheet on which the concealing code image is formed cannot acquire the secret code image in that state, but there is a possibility of easily recognizing that some kind of information is hidden there. On the other hand, in the above image forming apparatus 1, since the concealing code image that can be decoded is formed, it is difficult for the user to recognize that the secret code image is further formed under it. Therefore, it is possible to improve the degree of confidentiality of the code image (secret code image).

In the image forming apparatus 1, the concealing code image is formed so that the secret code image cannot be decoded. Therefore, the secret information is not acquired even if the user attempts a decoding processing using the code image at the position where the secret code image is formed. Therefore, it is possible to improve the degree of confidentiality of the code image (secret code image).

In the image forming apparatus 1, the sizes of the unit images coincide between the secret code image and the concealing code image. Therefore, it is difficult to determine that the secret code image is hidden behind the concealing code image. Therefore, it is possible to improve the degree of confidentiality of the code image (secret code image).

### (Modification)

In the image forming apparatus 1, the processing corresponding to Act S106 of the flowchart may be realized in any way. As described above, the processing may be realized by enabling the sheet to pass through the inversion unit 60 twice or may be realized by other means.

The processing in Act S105 and S107 of the flowchart may be executed at once if the image formation using the decoloring toner and the non-decoloring toner can be executed at once in the image forming apparatus 1. The processing in Act S106 becomes unnecessary.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a printer section configured to form an image using a decolorable recording agent; and
a controller configured to control the printer section to form a concealing code image for concealing a secret code image indicating secret information which corresponds to a concealed object in an area at least a part of the secret code image with the decolorable recording agent in such a manner that the secret code image formed on the sheet cannot be decoded.

2. The image forming apparatus according to claim 1, wherein
the printer section is further configured to form an image using a non-decoloring recording agent that cannot be decolorized, and
the controller is configured to acquire a secret code image indicating secret information which corresponds to a concealed object, form the secret code image with a non-decoloring recording agent, and then form the secret code image in such a manner that the secret code image formed by using the non-decoloring recording agent cannot be decoded.

3. The image forming apparatus according to claim 1, wherein
the controller is configured to acquire the concealing code image comprising unit images each having the same size as a unit image of the secret code image.

4. The image forming apparatus according to claim 2, wherein
the controller is configured to acquire the concealing code image comprising unit images each having the same size as a unit image of the secret code image.

5. The image forming apparatus according to claim 1, wherein
the controller is configured acquire a concealing code image having an amount of dark color parts at which the secret code image cannot be decoded according to an error correction capability of the secret code image with respect to a light color part of the secret code image.

6. The image forming apparatus according to claim 5, wherein
the controller is configured acquire the concealing code image by adding the dark color part within the error correction capability of a code image to the code image acquired by encoding predetermined information.

7. The image forming apparatus according to claim 1, wherein the controller is configured to correct at least one of an acquired secret code image or a concealing code image based on sizes of unit images of the acquired secret code image and the acquired concealing code image.

8. The image forming apparatus according to claim 1, wherein the controller is configured to acquire a secret code image and a concealing code image, wherein the acquired concealing code image is larger than the acquired secret code image.

9. The image forming apparatus according to claim 1, wherein the secret code image comprises one of a bar code image or a QR code image.

10. An image forming process, comprising:
forming an image using a decolorable recording agent; and
forming a concealing code image for concealing a secret code image indicating secret information which corresponds to a concealed object in an area at least a part of the secret code image with the decolorable recording agent in such a manner that the secret code image formed on the sheet cannot be decoded.

11. The process according to claim 10, further comprising:
forming an image using a non-decoloring recording agent that cannot be decolorized;
acquiring a secret code image indicating secret information which corresponds to a concealed object;
forming the secret code image with a non-decoloring recording agent, and then forming the secret code image in such a manner that the secret code image formed by using the non-decoloring recording agent cannot be decoded.

12. The process according to claim 10, further comprising:
acquiring the concealing code image comprising unit images each having the same size as a unit image of the secret code image.

13. The process according to claim 11, further comprising:
acquiring the concealing code image comprising unit images each having the same size as a unit image of the secret code image.

14. The process according to claim 10, further comprising:
acquiring a concealing code image having an amount of dark color parts at which the secret code image cannot be decoded according to an error correction capability of the secret code image with respect to a light color part of the secret code image.

15. The process according to claim 14, wherein
the concealing code image is acquired by adding the dark color part within the error correction capability of a code image to the code image acquired by encoding predetermined information.

16. The process according to claim 10, further comprising:
correcting at least one of an acquired secret code image or a concealing code image based on sizes of unit images of the acquired secret code image and the acquired concealing code image.

17. The process according to claim 10, further comprising:
acquiring a secret code image and a concealing code image, wherein the acquired concealing code image is larger than the acquired secret code image.
